(19) United States
(12) Patent Application Publication
(10) Pub. No.: US 2008/0170747 A1
(43) Pub. Date: Jul. 17, 2008

(54) Object Verification Method and System

(75) Inventor: Heros Dilanchian, Northbridge (AU)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Intelmail Explorenet Pty Ltd, Lane Cove (AU)

(21) Appl. No.: 11/946,093

(22) Filed: Nov. 28, 2007

(30) Foreign Application Priority Data
Nov. 28, 2006 (AU) 2006906655

(51) Int. Cl. G06K 9/00

(52) U.S. Cl. 382/101

(57) ABSTRACT

Provided is a method and system for detecting an object in a conveying system, where the object is one of a plurality of similar but otherwise distinctly individualized objects. The method comprises the steps of: sequentially conveying a group of objects past a first and optionally a second identification station arranged to read an indicia representing the individualization of each object; reading of the indicia of a first object when present at the first identification station; reading of the indicia of a second object when present at the first or second identification station; comparing the first and second indicia against a set of criteria and providing a positive or negative result of said comparison; and allowing said first object to be conveyed to a first location upon said comparison result being positive and otherwise conveying said first and second objects to a second location upon comparison result being negative.

### CROSS REFERENCE TO RELATED APPLICATIONS

This application claims priority under 35 U.S.C. §119(a) to Australian Application No. 2006906655 filed Nov. 28, 2006, which is incorporated by reference herein in its entirety.

### TECHNOLOGY FIELD

It is an object of the present invention to provide an alternative method for verifying the presence of an object in a sorting system which avoids the need for the sorting system to be halted whilst verifying the presence of an object in a sequence of objects.

### SUMMARY

In a first aspect, the present invention provides a method for verifying the presence of an individualized object in an object conveying system, the object being one of a plurality of similar but otherwise distinctly individualized objects, the method comprising the steps of: sequentially conveying a group of said objects past a first and optionally past a second identification station arranged to read an indicia representative of the individualization of each object; reading of the indicia of a first such object when present at the first identification station; reading of the indicia of a second such object when present at the first or the second identification station; comparing the first and second indicia against a set of criteria and providing a positive or negative result of said comparison; and allowing said first object to be conveyed to a first location upon said comparison result being positive and otherwise conveying said first and second objects to a second location upon the comparison result being negative.

Implementation of the present invention allows an automated forwarding or sorting system to continue operation where one of a group of individualized objects is missing from a sequential range. The inventors have recognized that in forwarding or sorting systems wherein a sequence of individualized objects are conveyed from one location to another, an individualized object missing from the range will most likely be caught up with either the preceding or succeeding object. Therefore, holding the first object in a holding position whilst the succeeding object is being identified or verified, allows for the diverting of both the preceding and succeeding objects if the objects are not in sequence. The presence of the missing object within these two objects can be verified at a later time either manually or by automated or semi-automated means. The system can therefore continue operation by repeating the verification method for the remaining objects, without the need for the halting of the process in the meantime, thus achieving the stated object.

In one form, the set of criteria comprises the objects being arranged in a predetermined sequence. In another form, the positive result comprises objects being arranged in a correct sequence, and the negative result comprises objects being arranged in an incorrect sequence.

In a second aspect, the present invention provides a method for verifying the presence of an individualized mail item in an automated mail forwarding system, the mail item being one of a plurality of similar but otherwise distinctly individualized mail items, the method comprising the steps of: sequentially conveying a group of said mail items past a first and optionally past a second identification station arranged to read an indicia representative of the individualization of each mail item; reading of the indicia of a first such mail item when present at the first identification station; reading of the indicia of a second such mail item when present at the first or the second identification station; comparing the first and second indicia against a set of criteria and providing a positive or negative result of said comparison; and allowing said first mail item to be conveyed to a first location upon said comparison result being positive and otherwise conveying said first and second mail items to a second location upon the comparison result being negative.

In one form, the set of criteria comprises the mail items being arranged in a predetermined sequence. In another form, a positive result comprises said mail items being arranged in a correct sequence, and a negative result comprises said mail items being arranged in an incorrect sequence.

Advantageously, the mail items comprise envelopes, and indicia is representative of name and/or address details of the intended recipient of the envelope.

In a third aspect, there is provided a system for verifying the presence of an individualized object in an object conveying system, the object being one of a plurality of similar but otherwise distinctly individualized objects, the system comprising: a conveyor for sequentially conveying a group of said objects; a first and optionally a second identification station arranged to read an indicia representative of the individualization of each object, wherein the first identification station reads the indicia of a first such object, and the first or the second identification station reads the indicia of a second such object; a processor for comparing the first and second indicia against a set of criteria and providing a positive or negative result of said comparison; and a diverter for allowing said first object to be conveyed to a first location upon said comparison result being positive and otherwise conveying said first and second objects to a second location upon the comparison result being negative.

In one form, the set of criteria comprises the objects being arranged in a predetermined sequence. In another form, a positive result comprises said objects being arranged in a correct sequence, and a negative result comprises said objects being arranged in an incorrect sequence.

In yet a fourth aspect, the present invention provides a system for verifying the presence of an individualized mail item in an automated mail forwarding system, the mail item being one of a plurality of similar but otherwise distinctly individualized mail items, the system comprising: a conveyer for sequentially conveying a group of said mail items; a first and optionally a second identification station arranged to read an indicia representative of the individualization of each mail item, wherein the first identification station reads the indicia of a first such mail item, and the first or the second identification station reads the indicia of a second such mail item; a processor for comparing the first and second indicia against a set of criteria and for providing a positive or negative result of said comparison; and a diverter for allowing said first mail item to be conveyed to a first location upon said comparison result being positive and otherwise conveying said first and second mail items to a second location upon the comparison result being negative.

In one form, the set of criteria includes the mail items being arranged in a predetermined sequence. In another form, a positive result comprises said mail items being arranged in a correct sequence, and a negative result comprises said mail items being arranged in an incorrect sequence.

Advantageously, the mail items comprise envelopes, and the indicia is representative of name and/or address details of the intended recipient of the envelope.

The indicia may include visually recognizable characters or signs, such as barcodes, numeral sequences, alphanumerical signs etc, which may be scanned by barcode readers and optical character recognition sensors, as the case may be. Other indicia may include magnetic barcodes and the reading means would be appropriately devised contact or contact-free magnetic sensors.

The set of criteria may include the objects (with their respective, individualizing indicia) being arranged in a sequence, e.g. indicia 1 followed by indicia 2 followed by indicia 3, or barcode 2 followed by barcode 4 followed by barcode 6, or sequence of groupings of objects, e.g. group 1 containing 6 objects with identical indicia X followed by group 2 containing 4 objects with indicia Y.

Whilst implementation of the above method may provide for the presence of a database in which the set of criteria is pre-stored and accessing of the database for the purpose of effecting the comparison, one form of the invention provides for arranging the means used for reading the indicia such that these recognize a sequence of indicia in a given order.

An illustrative embodiment of the present invention will now be described with reference to the accompanying drawings. Further features and advantages of the present invention will also become apparent from the accompanying description.

### BRIEF DESCRIPTION OF THE DRAWINGS

FIG. 1 shows a schematic diagram of verifying steps conducted in accordance with a method of one embodiment of the present invention;

FIG. 2 shows a schematic diagram of the system used to implement the embodiment of FIG. 1.

### DETAILED DESCRIPTION OF ILLUSTRATIVE EMBODIMENTS

An embodiment of the present invention will be described with reference to an automated mail printing and forwarding system. It will be appreciated however that the present invention is not so limited, and may be implemented in many other areas and industries, for many different uses, for example verifying the printing of employee's pay slips or notifications.

In the case of employee's pay slips, the printing of the payslip is done via an automated process, and the payslip is then automatically placed into an envelope ready for posting to the employee. The filled envelopes then require verification to ensure that all printed letters have actually been inserted individually into separate envelopes and have thus all proceeded to the exit point, to ensure all required letters are therefore posted to the correct employees. Each of the letters may not reach the exit point if, for example, two letters have been accidentally inserted into one envelope, or if one envelope has been misplaced or wrongly diverted during other stages of conveying within the system. The present invention may therefore be used to verify the correct pay slips are in the correct envelopes.

Another use may be during automated processes for entering data such as exam papers, where verification is required to ensure all exam papers have been accounted for and marked, and the papers entering the system have been entered against the correct person. The present invention may be used to verify the presence of the papers at the exit point of the system, and be matched with a database to ensure all have been correctly recorded. If one does not match the sequence and hence data in the database, the surrounding papers may be diverted and all accordingly checked.

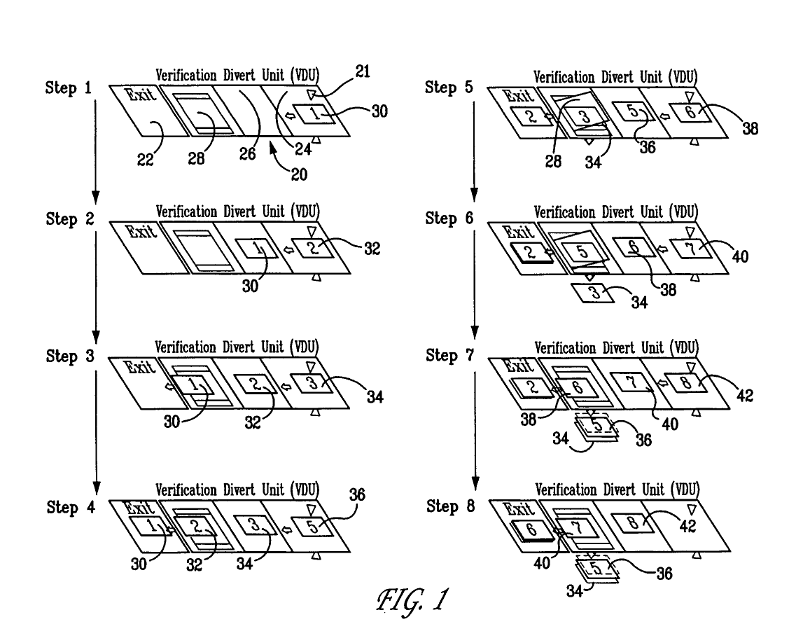

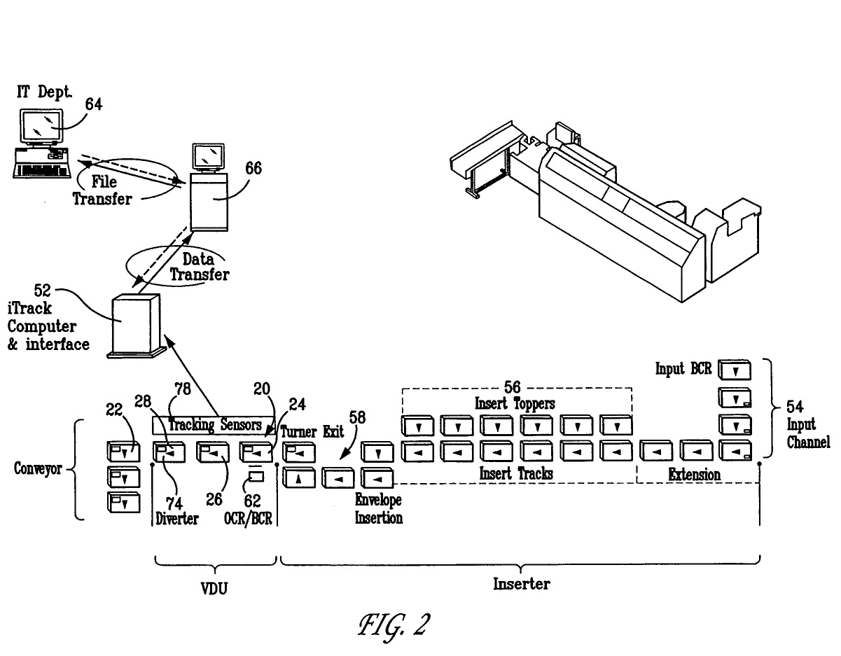

Turning to the implementation which will be described with reference to FIGS. 1 and 2, an automated mail printing and forwarding system, a predetermined number of the correspondence letters are first printed from a computerized database. The letters are each individualized with address details and preferably a corresponding barcode, indicative of an indicia representative of the individualization of each letter, printed thereon. Each barcode is entered onto a software database 52 at the time of printing, and the database 52 provides the envelopes with an order sequence.

The letters are then transported via conveyor means 54 to automatic envelope inserters 56, where each letter undergoes folding and insertion into an individual envelope. The address details and corresponding barcode are visible through a clear envelope window.

For simplicity, the present embodiment will be described with reference to only eight mail items (being letters and/or envelopes), although in practice a much larger number of letters is likely to be used, and the invention is not limited in this regard.

Each of the eight letters have been assigned an order reference labeled 1, 2, 3 . . . 8. The order reference is associated with the corresponding barcode and reflects the sequence or location of the letters in the group, i.e. “1” is the first letter in the sequence, “2” is the second letter in the sequence, etc. The order reference is to allow a processor to determine whether each envelope carrying the letter is in its correct sequence, and thereby produce a positive or negative result when passing through the verifying position. The sequence will be correct, i.e. provide a positive result, if the order references (and hence the letters or corresponding envelopes) are in the same sequence, 1, 2, 3 . . . 8 when they are read by the scanner connected to the processor as the letters were when initially printed from the database. Each of the envelopes is transported via additional conveyor means to a Verification Divert Unit 59.

FIG. 1 shows the Verification Divert Unit (“VDU”) 20 in further detail, followed by an exit conveyor 22. The VDU includes a reading position 24, a holding position 26, and a diverter 28. The VDU may optionally include a second reading position (not shown) between reading position 24 and holding position 26 or may be located at the holding position 26. Tracking sensors 78 are positioned above the reading and holding conveyors to track the timing and completion of the process.

As shown in FIG. 1, an object, in this case a first envelope 30 having the first letter printed out with order reference “1” enclosed, having a barcode (not shown) is positioned at the reading position 24. The barcode, i.e. indicia, is read via a barcode reader 62 (although any suitable device may be used, such as a contact-free magnetic sensor or OCR for example) whilst the first envelope 30 is so positioned to allow the first envelope 30 to be identified. The barcode reader 62 is connected to a CPU 64 and a server 66, which contains the software database storing the identity details for the envelopes, and the associated order sequence for the range of envelopes. The identity associated with the barcode of the first envelope 30 is verified and processed by a central processing unit at step 1. The first envelope 30 is then transferred via conveyor means to the holding position 26.

While the first envelope 30 is at the holding position 26, a second envelope 32 is moved along to the reading position 24, as shown at step 2. The barcode, i.e. indicia, of the second envelope 32 is read by the barcode reader whilst it is in the reading position 24 to allow its identity to be established. The order reference details associated with the barcode of second envelope 32 are verified and processed by the central processing unit.

The order reference details of the second envelope 32 are then compared against the order reference details of the first envelope 30, to determine whether the two envelopes are in the correct sequence. For example, if the order reference for the first envelope 30 is “1”, and the order reference for the second envelope 32 is “2”, then the two envelopes 30 and 32 are in the correct sequence, being position “1” and position “2” on the database. In this case, the first envelope 30, equating to order reference “1”, is conveyed or transferred via conveyor means to a first location, the exit conveyor 22. The database held by the CPU is correspondingly updated to acknowledge that first envelope 30 has been verified and has been transferred to the exit conveyor 22.

Once the first envelope 30 has been moved from the holding position 26, the second envelope 32 is transferred from the reading position 24 across to the holding position 26. Whilst the second envelope 32 is being held at the holding position 26, a third envelope 34 is moved along to the reading position 24, as shown at step 3. Again, the identity and order details of the third envelope 34 are checked by the reader and CPU, and used to determine whether the second envelope 32 and the third envelope 34 are in the correct sequence. As the order reference for the third envelope 34 is “3”, then the second envelope 32 (order sequence “2”) and the third envelope 34 (order sequence “3”) are verified to be in the correct sequence, i.e. provide a positive result. Accordingly, the second envelope 32 is moved along to the first location exit conveyor 22, while the third envelope 34 is moved across to the holding position 26.

A fourth envelope 36 is now moved along to the reading position 24, as shown at step 4. Again, the order details of the fourth envelope 36 are checked by the reader and CPU and used to determine whether the third envelope 34 and the fourth envelope 36 are in the correct sequence. However, as the order reference for the fourth envelope 36 is “5”, the CPU recognizes that such order reference is not in correct sequence, since the correct sequence would provide for order reference “4”. In this case, the system provides a negative result, and assumes that the envelope corresponding with order reference “4” has been combined with either the third envelope 34 corresponding to order reference “3”, or the fourth envelope 36 corresponding to order reference “5”.

In practice, the missing envelope and hence missing letter is most likely to either have jumped position, and thus either be read before or after its correct sequence, or alternatively, be caught up with the preceding or succeeding envelope either by two letters and two envelopes being present but physically caught up together, or by two letters having been inserted into one envelope. To avoid the need to halt the system whilst the missing envelope and hence letter is found, the two suspect envelopes 34 and 36 will be conveyed or diverted onto a different path to the remaining verified envelopes, to a second location. The diverted envelopes 34 and 36 can then be manually or otherwise checked at a later time. In one embodiment, the two diverted envelopes 34 and 36 could be automatically diverted back through the VDU system to allow for a second verification.

Returning to FIG. 1, the third envelope 34, after determining it is “suspect”, is diverted by means of the diverter 28. The second suspect envelope 36, is however moved across from the reading position 24 to the holding position 26, where it is held until its successive envelope, the fifth envelope 38, is moved onto the reading position 24 and subsequently had its details checked and verified by the reader and CPU, as shown at step 5. As the fifth envelope 38 has its order reference as “6”, this is verified to be in sequence with its preceding envelope, fourth envelope 36, which had its order reference as “5”. Following from this verification, fourth envelope 36, being the second suspect envelope, is then diverted via the diverter 28, whilst the fifth envelope 38 is moved across to the holding position 26. The fifth envelope 38 remains at the holding position 26 whilst its successive envelope, sixth envelope 40, is checked by the reader and CPU, as shown at step 6. Since the sixth envelope 38 is in the correct order, with order sequence of “7”, the fifth envelope 36 is moved along to the exit conveyor 22.

The sixth envelope 40 is moved across to the holding position 26, whilst its successive envelope, the seventh envelope 42, is read and checked at the reading position 24, as shown in step 7. Since the seventh envelope 42 is also verified to be in sequence, with order number “8”, the sixth envelope 40 is moved along to the exit conveyor 22, while the seventh envelope 42 is moved along to the holding position 26, as shown in step 8. Since the seventh envelope 42 is verified to be the last envelope in the range, it too moves along to the exit conveyor 22 without the need to be verified with a succeeding envelope.

At the conclusion of the sequence verification process for the range, the suspect envelopes will be manually checked to determine whether the missing envelope is present and has simply been physically caught up with either the preceding or succeeding envelope. If so, the verification details can be manually added to the database listing, and the three envelopes can be placed on the exit conveyor for dispatch. If the missing envelope is not found to be caught up with either the preceding or succeeding envelope, corresponding details can then be entered onto the database, and the suspect envelopes can be checked for more than one letter having been inserted therein. New correspondence associated with the missing and suspect envelopes can then be produced.

The process therefore allows the presence of the envelopes to be verified as having been sent to dispatch, thus ensuring that all correspondence has been correctly dispatched.

The present embodiment therefore allows the verification of the presence of each of the envelopes in the range without the need to stop the system and have it manually checked each time an envelope is detected to be missing. This allows for significant time and cost savings, since the system can continuously operate.

Depending upon the dimensions and shape of the object being verified, the system can operate at very high speeds, wherein each step of the process is conducted in 0.1 seconds or less. The present system can also be adapted to fit different types of verification objects, and is not limited to envelopes or any particular kind of objects or medias. Furthermore, the present invention may be implemented on its own, or part of other machines, such as plastic wrapping machines, or barcode creators for example.

The reading of the order sequence may be done from either above or below the item, or, for items with substantial height, from the side. The verification described in the present embodiment was performed via a database, which is the most appropriate method for randomly numbered or identified items. In this case, the database initially applies an order sequence to the randomly numbered objects, and the reader reads the random number and this random number is then verified with the order sequence initially applied by the CPU and the database. An alternative embodiment may be for the items to be labeled in sequence, such as in sequence barcode labels 1, 2, 3 etc, such that the database does not need to apply an order sequence to each object itself. In an alternate embodiment, verification with a database may not be required at all during the sorting process, rather, the reader itself may simply recognize the sequential numbers. A further alternative embodiment may use optical character recognition (OCR) in place of a barcode and barcode reader.

It will be appreciated that persons skilled in the art could implement the present invention in different ways to the one described above, and variations may be produced without departing from its spirit and scope. The presently described embodiment is for illustrative purposes only, and is not intended to be limiting.

Any discussion of documents, acts or knowledge in this specification is included to explain the context of the invention. It should not be taken as an admission that any of the material forms part of the prior art base or the common general knowledge in the relevant art.

What is claimed:

1. A method for verifying the presence of an individualised object in an object conveying system, the object being one of a plurality of similar but otherwise distinctly individualised objects, the method comprising the steps of:
sequentially conveying a group of said objects past a first and optionally past a second identification station arranged to read an indicia representative of the individualisation of each object;
reading of the indicia of a first such object when present at the first identification station;
reading of the indicia of a second such object when present at the first or the second identification station;
comparing the first and second indicia against a set of criteria and providing a positive or negative result of said comparison; and
allowing said first object to be conveyed to a first location upon said comparison result being positive and otherwise conveying said first and second objects to a second location upon the comparison result being negative.

2. A method according to claim 1, wherein the set of criteria comprises the objects being arranged in a predetermined sequence.

3. A method according to claim 1, wherein said positive result comprises objects being arranged in a correct sequence, and said negative result comprises objects being arranged in an incorrect sequence.

4. A method for verifying the presence of an individualised mail item in an automated mail forwarding system, the mail item being one of a plurality of similar but otherwise distinctly individualised mail items, the method comprising the steps of:
sequentially conveying a group of said mail items past a first and optionally past a second identification station arranged to read an indicia representative of the individualisation of each mail item;
reading of the indicia of a first such mail item when present at the first identification station;
reading of the indicia of a second such mail item when present at the first or the second identification station;
comparing the first and second indicia against a set of criteria and providing a positive or negative result of said comparison; and
allowing said first mail item to be conveyed to a first location upon said comparison result being positive and otherwise conveying said first and second mail items to a second location upon the comparison result being negative.

5. A method according to claim 4, wherein the set of criteria comprises the mail items being arranged in a predetermined sequence.

6. A method according to claim 4, wherein said mail items comprise envelopes.

7. A method according to claim 6, wherein said indicia is representative of name and/or address details of the intended recipient of the envelope.

8. A method according to claim 4, wherein said positive result comprises said mail items being arranged in a correct sequence, and said negative result comprises said mail items being arranged in an incorrect sequence.

9. A system for verifying the presence of an individualised object in an object conveying system, the object being one of a plurality of similar but otherwise distinctly individualised objects, the system comprising:
a conveyor for sequentially conveying a group of said objects;
a first and optionally a second identification station arranged to read an indicia representative of the individualisation of each object, wherein the first identification station reads the indicia of a first such object, and the first or the second identification station reads the indicia of a second such object;
a processor for comparing the first and second indicia against a set of criteria and providing a positive or negative result of said comparison; and
a diverter for allowing said first object to be conveyed to a first location upon said comparison result being positive and otherwise conveying said first and second objects to a second location upon the comparison result being negative.

10. A system according to claim 9, wherein the set of criteria comprises the objects being arranged in a predetermined sequence.

11. A system according to claim 9, wherein said positive result comprises said objects being arranged in a correct sequence, and said negative result comprises said objects being arranged in an incorrect sequence.

12. A system for verifying the presence of an individualised mail item in an automated mail forwarding system, the mail item being one of a plurality of similar but otherwise distinctly individualised mail items, the system comprising:
a conveyer for sequentially conveying a group of said mail items;
a first and optionally a second identification station arranged to read an indicia representative of the individualisation of each mail item, wherein the first identification station reads the indicia of a first such mail item, and the first or the second identification station reads the indicia of a second such mail item;
a processor for comparing the first and second indicia against a set of criteria and for providing a positive or negative result of said comparison; and
a diverter for allowing said first mail item to be conveyed to a first location upon said comparison result being positive and otherwise conveying said first and second mail items to a second location upon the comparison result being negative.

13. A system according to claim 12, wherein the set of criteria includes the mail items being arranged in a predetermined sequence.

14. A system according to claim 12, wherein said mail items comprise envelopes.

15. A system according to claim 14, wherein said indicia is representative of name and/or address details of the intended recipient of the envelope.

16. A system according to claim 12, wherein said positive result comprises said mail items being arranged in a correct sequence, and said negative result comprises said mail items being arranged in an incorrect sequence.
